(19) United States
(12) Patent Application Publication
(10) Pub. No.: US 2006/0247809 A1
(43) Pub. Date: Nov. 2, 2006

(54) Data display control device

(76) Inventors: Noriyuki Sakoh, Tokyo (JP); Takeshi Iwatsu, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/566,630

(22) PCT Filed: Aug. 6, 2004
(86) PCT No.: PCT/JP04/11664

§ 371 Date: Jan. 31, 2006

(30) Foreign Application Priority Data
Sep. 30, 2003 (JP) 2003-339723

(51) Int. Cl. G06F 17/00

(52) U.S. Cl. 700/94

(57) ABSTRACT

According to the present invention, at least one data is searched from the data with the first size, from the database based on the input search key and by controlling to obtain partial data with the second size corresponding to the display size that is smaller than the first size and to display it on the display. Thus, it is not necessary to display the whole data with the first size, but only the partial data corresponding to the second size, that is the display size, is needed to obtain and display, making it possible to display and provide the data in a short time, without burdening with such load as the data conversion to fit to the display size, and the like.

### TECHNICAL FIELD

The present invention relates to a data display control device, preferably applied to a case to read-out and display music information such as the title of the music and the name of the artist, being stored on a hard disk, for example.

### BACKGROUND OF THE INVENTION

Conventionally, there are such methods as to adapt transmitted information to the functions of a network terminal based on the network terminal property, when transmitting the source information from the information server to the mutually connected network terminal device of the network. (For example, refer to Patent Document 1)

Patent Document 1 Japanese Patent Application No. 2001-236286

Incidentally in the aforementioned method, there was a problem that it was difficult to provide the information quickly to the network terminal user, since it took a long time to deliver the information from the server to the network terminal when the network traffic was busy, and it also took a long time for the conversion processing of the source information to match the network terminal functionality, for example.

### DISCLOSURE OF THE INVENTION

Above problem has been considered in the present invention and a data display control device that can provide the information to the user in a short period of time is proposed.

In order to solve the problem, the data display control device of the present invention is consisted of: a database, with at least a plurality of data with one size (hereinafter called the first size), being included, a search method for searching at least one data from the plurality of the first size data of the database based on the input search key, and a control means to obtain and also to display a partial data that is a part of the first size data with smaller size (hereinafter called the second size) corresponding to the size of the display that is smaller than the first size, from at least one data found by the search method.

Thereby, since only the part of the searched data with the first size, the partial data corresponding to the second size with the size of the display can be obtained from the database and displayed, it is possible to deliver the data in a short time avoiding such load as conversion processing to fit the size of the display.

Further, the data display control method of the present invention is to be configured with a search step to search at least one data from the database including at least a plurality of data with the first size, based on the input search key, and a control step to obtain the partial data that is a part of at least one data found in the search step that is smaller than the first size and matching with the second size corresponding to the size of the display and show it in the display at the same time.

Thereby, since only the partial data matching with the second size corresponding to the size of the display, not the entire data with the first size is obtained from the database and displayed, it is possible to deliver and display the data in a short time without such burden as the conversion processing for adapting to the size of the display.

Further, the data display control program of the present invention configures the data display control device with a search step to search at least one data from the database including at least a plurality of data with the first size, based on the input search key, and a control step to obtain the partial data that is a part of at least one data found in the search step, smaller than the first size and matching with the second size corresponding to the size of the display and show it in the display at the same time.

Thereby, since only the partial data matching with the second size corresponding to the size of the display, not the entire data with the first size, is obtained from the database and displayed, it is possible to deliver and display the data in a short time without such burden as the conversion processing for adapting to the size of the display.

The present invention makes it possible to realize a data display control device, a data display control method and a data display control program to deliver and display the data in a short time without such burden as the conversion processing for adapting to the size of the display, since only the partial data matching with the second size corresponding to the size of the display, not the entire data with the first size, is obtained from the database and displayed.

### BRIEF DESCRIPTION OF THE DRAWINGS

FIG. 1 is a schematic diagram illustrating the entire configuration of the information service system according to the present invention.

FIG. 2 is a schematic block diagram illustrating the configuration of a radio station.

FIG. 3 is a schematic block diagram illustrating the configuration of a URL information server.

FIG. 4 is a schematic block diagram illustrating the configuration of a relevant information server.

FIG. 5 is a schematic block diagram illustrating the circuit configuration of a client terminal.

FIG. 6 is a schematic diagram illustrating the contents directory management.

FIG. 7 is a schematic diagram illustrating the program modules of the client terminal.

FIG. 8 is a flow chart illustrating the search result acquisition and display processing procedure.

FIG. 9 is a schematic diagram illustrating the structure of the configuration information.

FIG. 10 is a schematic diagram illustrating the contents of the list definition and the item definition.

FIG. 11 is a schematic diagram illustrating a concrete example of the list definition and the item definition.

FIG. 12 is a schematic diagram illustrating the display area of the display.

FIG. 13 is a schematic diagram illustrating a horizontal scroll display.

FIG. 14 is a schematic diagram illustrating a vertical scroll display.

### BEST MODE FOR CARRYING OUT THE INVENTION

Preferred embodiment of the present invention will be hereinafter described with reference to accompanying drawings.

(1) Over all Configuration of the Information Service System

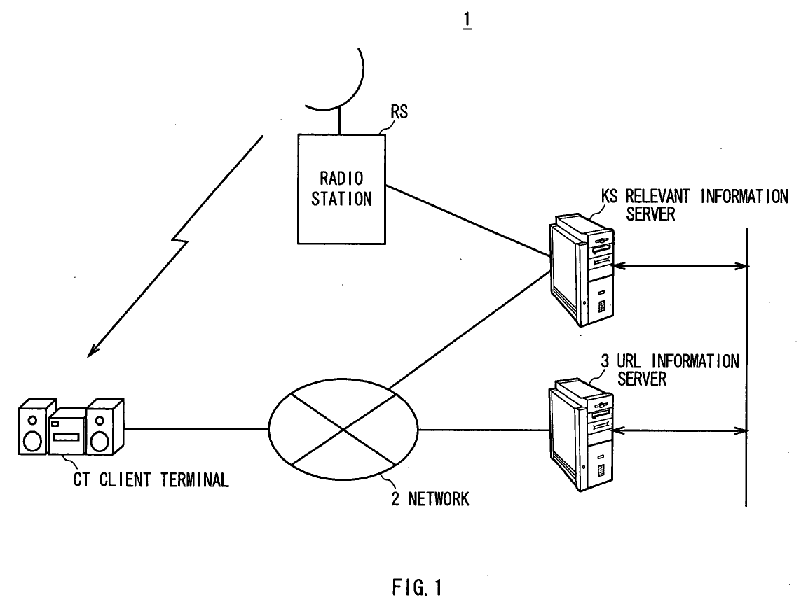

As shown in FIG. 1, the information service system 1 indicates the entire system comprising the present invention. The client terminal CT is configured such that it can receive the broadcast from the radio station RS, and at the same time, it can also receive the music information as relevant information, that is provided by the radio station home page through the Internet 2 from the relevant information server KS connected to the radio station RS by a private line.

Further, the information service system 1 is configured such that the relevant information server KS notifies the URL (Uniform Resource Locator) information indicating the access destination of the information service it provides through the home page, etc., to the URL server 3.

Accordingly, the URL server 3 is configured such that it can provide the latest URL to the inquiry about the access destination from the client terminal CT to the information service of the radio station RS, even when the access destination URL of the information service is changed by bookkeeping the URL changes.

Here, since the receivable area of the radio broadcasting service is limited, the same frequency is sometimes commonly used in a plurality of areas. For example, 80.0 MHz is assigned to FM Tokyo in the metropolitan area, while it is assigned to FM Aomori in the Tohoku area.

Therefore, the radio station RS may not be identified by specifying the frequency only to the URL server 3 from the client terminal CT. So, it is configured that the URL, indicating the access point of the information service of the radio station RS, is provided by notifying specific information called “call sign” to the URL server 3.

(1-1) Configuration of the Radio Station RS

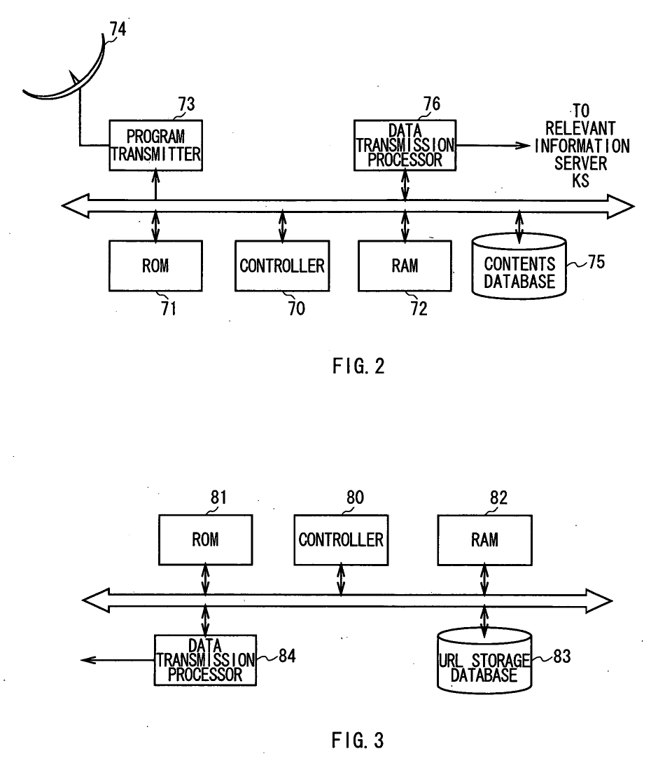

As shown in FIG. 2, the radio station RS is configured such that the controller 70 consisted of a CPU configuration having ROM 71 and RAM 72 controls the system as a whole and the radio programs are broadcast to the client terminal CT from the program transmission part 73 through the antenna 74.

The radio station RS has a lot of music contents to be broadcast in the radio programs and the radio program contents recorded in advance in the hard disk 74, and the information about the music broadcast in the radio program and which radio program was broadcast is notified to the relevant information server KS through the read out data transmission processing part 76 as required.

(1-2) Configuration of the URL Server

As shown in FIG. 3, the URL server 3 is configured such that the controller 80 with the CPU configuration having ROM (Read Only Memory) 81 and RAM (Random Access Memory) 82 engages in the entire system control and specific computation processing, etc., based on the basic programs such as the OS (Operating System) and various application programs, read out from the ROM 81 and laid onto the RAM 82.

The URL server 3 is configured to search the URL of the home page of the radio station RS corresponding to the call sign from the URL database 83, upon receiving the call sign from the client terminal CT and send it back to the client terminal CT through the data transmission processing part 84.

Besides, the URL server 3 is configured such that it is also connected to the relevant information server KS, it receives the service status of the relevant information server KS as status information through the data transmission processing part 84 and it can provide the state information along with the URL to the client terminal CT.

(1-3) Configuration of the Relevant Information Server

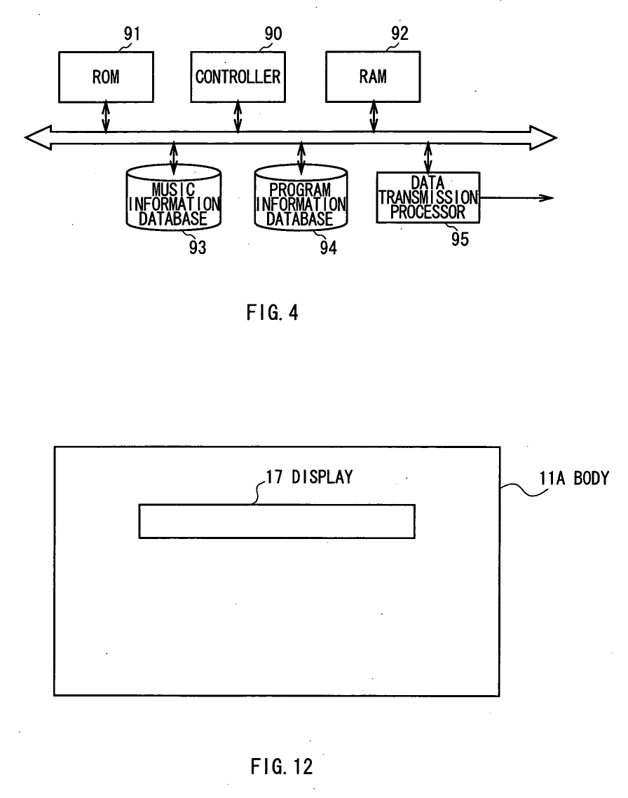

As shown in FIG. 4, the relevant information server KS is configured such that the controller 90 with the CPU configuration having ROM 91 and RAM 92 engages in the entire system control and specific computation processing, etc., based on the basic programs such as the OS (Operating System) and various application programs, read out from the ROM 91 and laid onto the RAM 92.

The relevant information server KS searches the music information of the music broadcast in the radio program of the radio station RS from the music information database 93, for example, and provides it to the client terminal CT through the data transmission processing part 95.

Besides, the relevant information server KS searches the program information such as the performer, DJ's name, genre, etc., relevant to the radio program broadcast by the radio station RS from the program information database and provides it to the client terminal CT through the data transmission processing part 95.

(1-4) Circuit Configuration of the Client Terminal CT

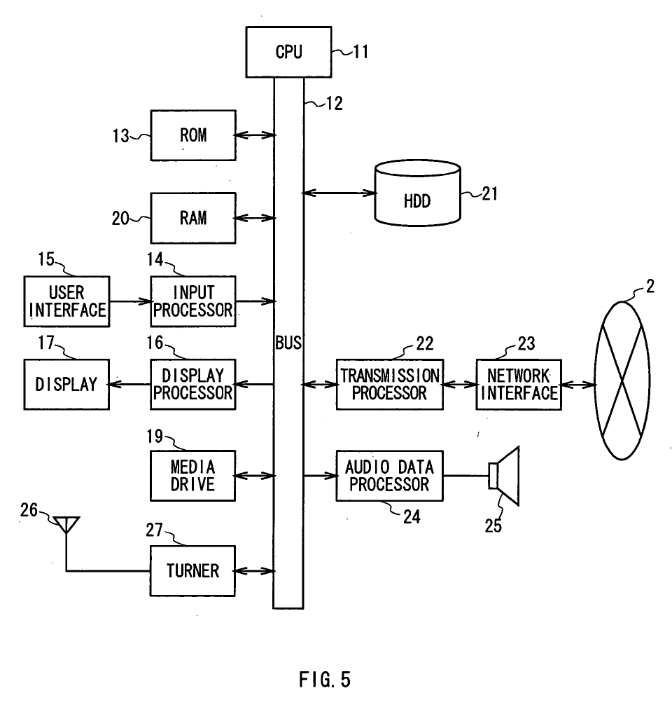

As shown in FIG. 5, the CPU (Central Processing Unit) 11 of the client terminal CT is configured to engage in the entire system control and specific computation processing, etc., based on the basic program such as the OS (Operating System) and various application programs, read out from the ROM (Read Only Memory) 13 and laid onto the RAM (Random Access Memory) 20. It performs, for example, the transmission operation through the network such as the Internet 2, input/output operation to/from users, playing the contents from the media, ripping the down-loaded contents from the radio station RS, writing the contents into the hard disk drive (HDD) 21 and management of the contents, etc.

The operation input part 15 transmits input information corresponding to various operators on the chassis surface or a remote controller (not shown) to the input processing part 14, and after some specific processing is performed in the input processing part 14, it is sent to CPU 11 as an operation command.

The CPU 11 is configured to execute processing corresponding to the operation command.

The display 17 being configured to display the processing results of CPU 11 or other sort of information may be a liquid crystal display directly attached on the chassis surface or an external display device.

The media drive 19 is a device such as CD drive to play CD (Compact Disc) or memory stick (registered trade mark) consisted of flash memory, etc., being configured to output the result of the reproduced sound from the 2 channel speakers 25 after digital analog conversion with the audio data processing part 24.

Besides, when the data played by the media drive 19 is audio contents, CPU 11 can store the data in the hard disk drive 21 as an audio data file.

Further, the CPU 11 can also read out a plurality of still pictures stored in the memory stick (registered trademark), using media drive 19, and sequentially display these as a slide show on the display 17 through the display processing part 16.

The tuner part 27 may be an AM-FM radio tuner, for example, that demodulates the broadcast signal received from the antenna 26 with the control by CPU 11, and output the result as the broadcast sound from the speaker 25 through the audio data processing part 24.

The transmission processing part 22 is configured such that it executes encode processing for the data transmission with the control of the CPU 11, transmits the data to an external network device via the Internet 2 through the network interface 23, decodes the received data from an external network device through the network interface 23, and transfers the data to the CPU 11.

(1-5) Directory Management of the Contents

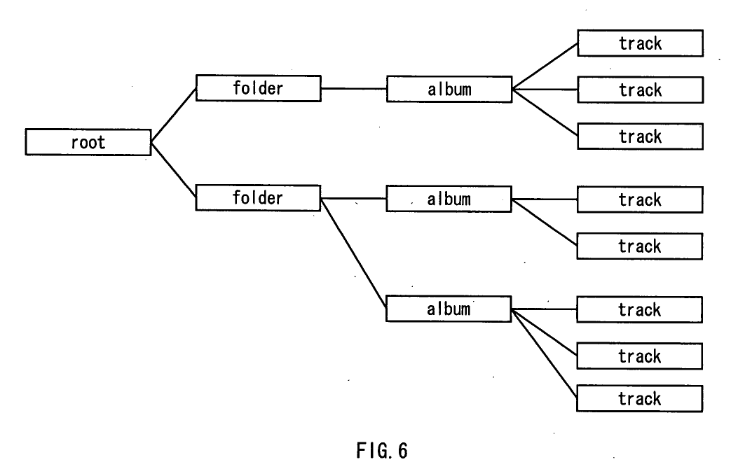

The CPU 11 of the client terminal CT manages the contents with the directory configuration shown in FIG. 6 when storing contents in the hard disk drive 21. Firstly, any number of folders within the predefined number can be placed in the sub-layer of the root directory. This folder is configured to be created corresponding to the contents genre or the owner, etc., for example.

Any number of albums within a predefined number can be placed in the sub-layer of this folder, and the albums may correspond to the respective album titles, for example.

It is configured that one or more tracks, supposedly belong to the album are placed under such album directory. The unit data of respective tracks is a music title consisting the contents.

It is configured that such directory management of the contents is performed with the database files stored in the hard disk drive 21.

(1-6) Program Module Configuration of the Client Terminal CT

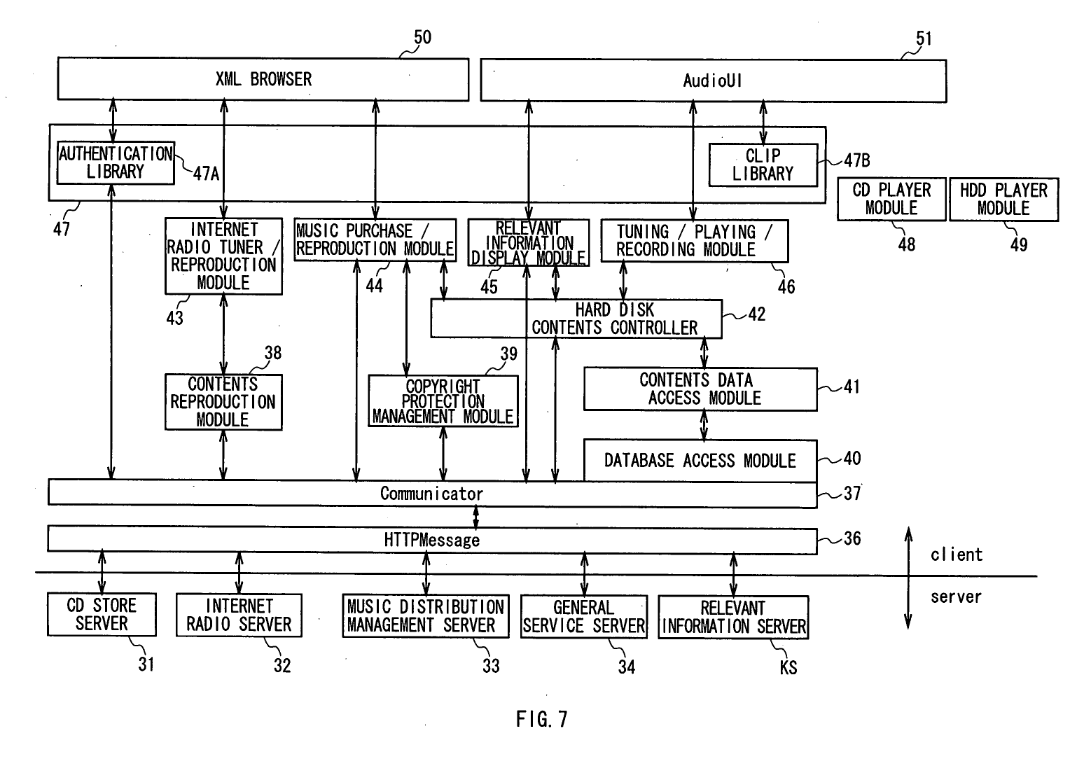

As shown in FIG. 7, the program modules of the client terminal CT are configured to run on the OS, specifically, they interact with various servers such as a CD store's server 31, who sells CDs, the Internet radio server 32, music distributor's server 33, general service server 34 and relevant information server KS.

The HTTP (Hyper Text Transfer Protocol) message program 36 interacts with various servers such as the CD store's server 31, the Internet radio server 32, the music distributor's server 33, general service server 34 providing various general services and relevant information server KS, etc., through the HTTP communication, and the communicator program 37 is a program module, which exchanges data with the HTTP message program 36.

The contents reproduction module 38, which encodes to play the contents and the copyright protection information management module 39, which handles the copyright protection information, are positioned on the upper layer of the communicator program 37, and the Internet radio tuning and reproducing module 43 for tuning and reproducing the Internet radio and the music purchasing reproducing module 44, which handles the music purchasing and reproduction for pre-listening the music, for the contents reproduction module 38 and copyright protection information management module 39, respectively, are placed.

The XML (extensible Markup Language) browser 50, that interprets XML files from various servers and displays on the display 17 is placed on the upper layer of the Internet radio tuning and reproducing module 43 and music purchasing reproducing module 44.

For example, the music, selected by the user through the XML browser 50, is purchased by the music purchasing and reproducing module 44 and is written into the hard disk drive 21 (FIG. 5) through the hard disk contents controller 42.

In addition, the authentication library 47A of the library 47 is connected to the communicator program 37 and it is configured that the authentication library 47A performs the authentication processing of the general service server 34 and various other servers.

Furthermore, on the upper layer of the communicator program 37, the database access module 40, the contents data access module 41 and the hard disk contents controller 42 are placed.

It is configured that the database access module 40 accesses various databases implemented in the hard disk drive 21, the contents data access module 41 accesses the contents stored in the hard disk drive 21 and the hard disk contents controller 42 manages the contents stored in the hard disk drive 21.

On the upper layer of the hard disk contents controller 42, the relevant information display module 45 to display the title and the artist name of the music broadcast by the radio station RS, and the tuning selecting and reproducing/recording module 46 to select the radio station RS and to record the music contents received from said radio station RS, are placed.

For example, the music received from the radio station RS, which is selected through the audio user interface (UI) 51, is configured to be written into the hard disk drive 21 through the contents data access module 41.

The relevant information display module 45 receives the title and the artist name of the music currently broadcast by the radio station RS from the relevant information server KS, as a related information through the HTTP message 36, by means of the tuning selecting and reproducing/recording module 46, and displays it through the audio user interface 51 on the display 17.

Additionally, the related information displayed through the audio user interface 51 on the display 17 may be temporarily stored in the clip library 47B of the library 47 as well, and is configured finally to be stored in the hard disk drive 21 through the database access module 40 according to the instruction from the user.

Besides, the CD reproduction module 48 for reproducing CD and the HDD reproduction module 49 for reproducing the hard disk drive 21 are included in the program module of the client terminal CT, and output the reproduction result through the audio data processing part 24 and the speaker 25.

(2) Acquisition of the Search Result and Display Processing

It is configured that the client terminal CT acquires the music information of the music broadcast by the radio station RS through the home page of the relevant information server KS, and stores it in the music information storage area of the hard disk drive 21. Now, the procedure to readout the music information that is the result of the search by the user's instruction from the music information storage area of the hard disk drive 21 again and to display the music information on the display 17 is explained.

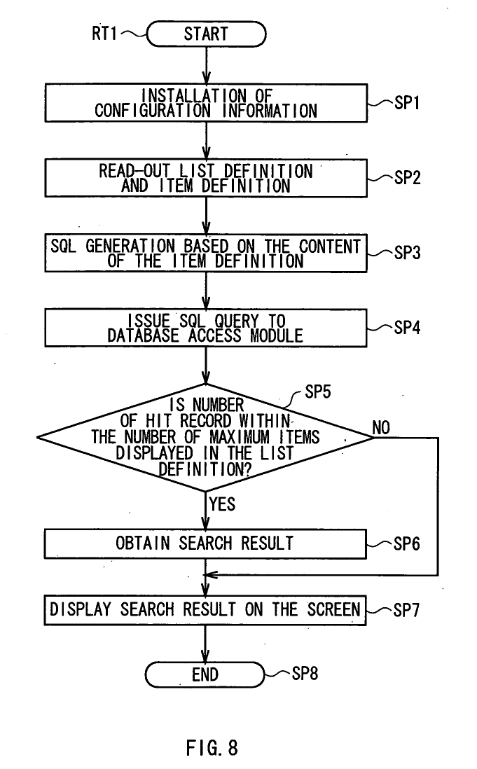

As shown in FIG. 8, the CPU 11 of the client terminal CT enters from the starting step of the routine RT1, then moves to the next step SP1, and registers the configuration information (described later) in the hard disk drive 21 first, then moves to the next step SP2.

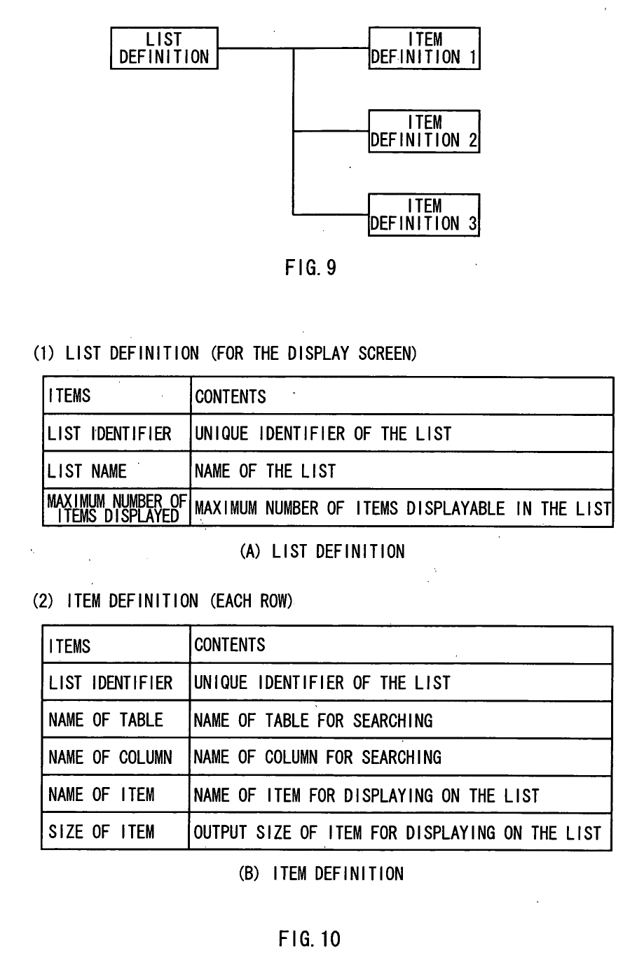

As shown in FIG. 9, the configuration information is configured in advance considering the processing power of the CPU 11 of the client terminal CT and the display capability of the display 17 of the client terminal CT to limit the search range of the music information and is stored in the hard disk drive 21 to constitute a database.

Specifically, the configuration information is composed of two levels, a list definition for an entire list view of music information (a screen unit), and an item definition for each line of the list definition (an item unit), the item definition 1 through the item definition 3, for example, and the item definition 1 through the item definition 3 may be either singular or plural, and, further, item definitions may also be defined in the lower layer of the item definition 1 through the item definition 3.

As shown in FIG. 10(A), it is configured that the list definition has attributes that can be specified; a list identifier for an unique representation of a list of the music information, a list name as the name of the list and a maximum number of items displayed indicating the maximum number (number of lines) can be displayed in the list.

Further, as shown in FIG. 10(B), it is configured that the item definition has attributes that can be specified; a list identifier for an unique representation of a list of the music information similar to the list definition, a table name for identifying the table to be searched, a column name for identifying the column to be searched, an item name for displaying in the list and an item size for the output size of the display items in the list may be specified.

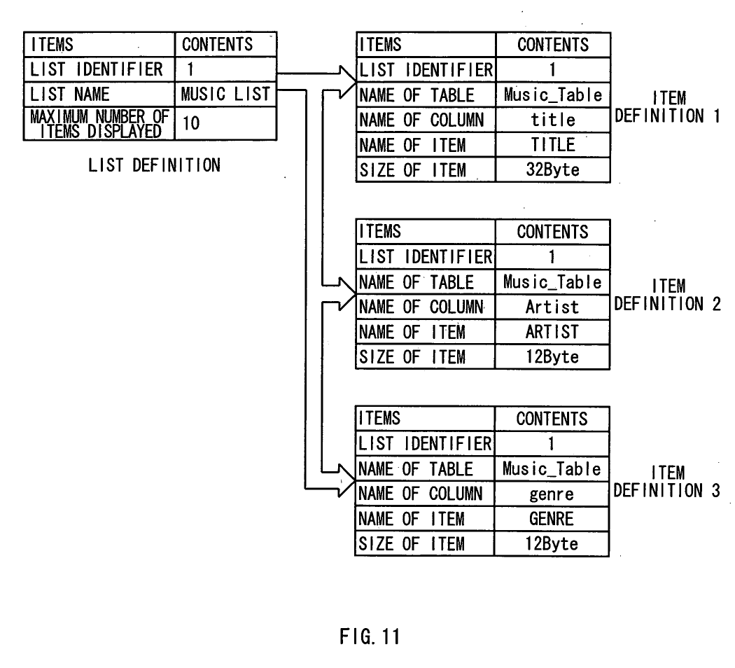

In fact, as shown in FIG. 11, in the list definition, the list identifier is specified as “1”, list name as “music list”, and the number of maximum items displayed as “10”.

On the other hand, in the item definition 1, the list identifier is specified as “1”, name of the table as “Music_Table”, column-name as “title”, item name as “Title”, and item size as “32 Byte”.

Further, in the item definition 2, the list identifier is specified as “1”, table name as “Music_Table”, column name as “Artist”, item name as “Artist”, and item size as “12 Byte”.

Further, in the item definition 3, the list identifier is specified as “1”, table name as “Music_Table”, column name as “genre”, item name as “Genre”, and item size as “12 Byte”.

Thus, when searching music information, it is configured that the client terminal CT can obtain the search result of the music information within the specified range based on the configuration information, by making a database of the configuration information specified in terms of the list definition and the item definition in advance and storing it in the hard disk drive 21.

Thus, since it is only time consuming and meaningless if the client terminal CT tried to obtain a search result beyond the processing capability of the CPU 11 or the display capability of the display 17, it is configured that the search result can be efficiently obtained based on the configuration information and quickly after the search command is actually given by the user.

That is, for example, when the list definition and the item definition 1 are put in, it may be configured that the client terminal CT is limited to obtain up to ten titles from the music information storage area of the hard disk drive 21 as a search result, and also it is limited to read out only 32 [Byte] of the data from the top specified by the item size, if ever the total size of the title is 256 [Byte].

Similarly, for example, when the list definition and the item definition 1 through the item definition 3 are put in, it may be configured that the client terminal CT is limited to obtain up to ten items of the artists and genre from the music information as a search result from the music information storage area of the hard disk drive 21, and also, for the title, it is limited to obtain by reading out only 32 [Byte] of the data from the top specified by the item size, if ever the total size of the title is 256 [Byte] and also, for the artist name, only 12 [Byte] is obtained by reading out from the top, and for the genre only 12 [Byte] is obtained by reading out from the top, respectively.

In the step SP2, the CPU 11 of the client terminal CT reads out, for example, the list definition and the item definition 1 stored in advance, from the hard disk drive 21, then moves to the next step SP3.

In the step SP3, the CPU 11 of the client terminal CT creates a SQL (Structured Query Language) command to issue a search key based on the content of the list definition and the item definition 1 to the database access module 40, then moves to the next step SP4.

In the step SP4, the CPU 11 of the client terminal CT issues the SQL command created in the step SP3, to the database access module 40, then moves to the next step SP5.

Thereby, the database access module 40 searches the music information storage area of the hard disk drive 21 based on the SQL command. Then upon obtaining the search result, the CPU 11 of the client terminal CT, evaluates whether the number of records of the music information corresponding to the search key, is within the number of maximum items displayed specified in the list definition or not.

Here, if a negative result is obtained, since the number of records of the search result exceeds the number of maximum items displayed, the CPU 11 of the client terminal CT judges that it exceeds the processing power of the CPU 11 or the display capability of the display 17, and moves to the next step 17.

In the step SP7, the CPU 11 of the client terminal CT displays a message that “Unable to display because the search result exceeds the number of maximum items displayed.” on the display 17, then moves to the next step SP8 and terminate the processing.

On the other hand, when a positive result is obtained in the step SP5, the CPU 11 of the client terminal moves to the next step SP6 and takes the search result within the number of maximum items displayed, retrieves the 32 [Byte] of each title from the top according to the item size of the item definition 1 from the music information storage area of the hard disk drive 21, then moves to the next step SP7.

In the step SP7, for example, if the body 11A of the client terminal CT is equipped with a display 17 with a small display area that can display only 1 line with 24 characters (a total of 24 [Byte] with 1 character=1 [Byte]), as shown in FIG. 12, the CPU 11 of the client terminal CT displays the title only 24 characters from the top and moves to the next step SP8 to terminate the processing.

In addition, the item size of the item definition 1 may be specified in advance so that the CPU 11 of the client terminal CT will obtain the title of the data size (24 [Byte]), which completely coincides with the number of characters of the display area of the display 17.

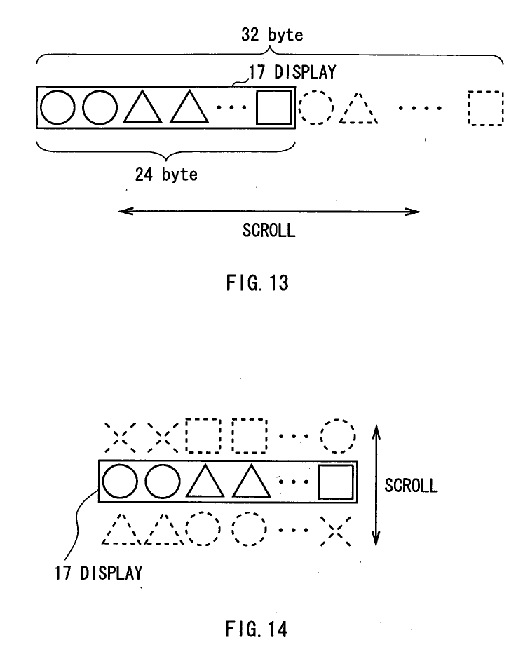

However, as shown in FIG. 13, when the processing power of the CPU 11 is sufficient to display more than 24 characters, even if the display capability of the display 17 is 24 characters, it is configured such that the title can be displayed by lateral scroll since a title up to 32 [Byte] can be obtained, by specifying the item size of the item definition 1 such that it can obtain, a little bigger, 32 [Bytes] of data.

Thereby, even when the title is longer than 24 characters, the user can instantly recognize it through the scroll display.

Incidentally, it is configured that the CPU 11 of the client terminal CT obtains the part of data after the 32 [Byte] from the music information storage area of the hard disk drive 21 and displays it only when the instruction for subsequent scrolling is given from the user.

In addition, as shown in FIG. 14, it is also configured that when the CPU 11 of the client terminal CT has obtained three titles for example, within the number of maximum items displayed, it can immediately scroll to display longitudinally on the display 17, following the user's instruction after the first title is displayed. Besides, in this case, all the three titles are obtained with the data size following the item size specified in the item definition.

(3) Processing and Effects

In the above configuration, the configuration information is stored as a database in the hard disk drive 21, with the list definition and the item definition 1 through the item definition 3 in advance, so that the client terminal CT of the information service system 1 can efficiently obtain and quickly display the music information as the search result within the range of the processing power of the CPU 11 and the display capability of the display 17.

Thereby, even when the display area of the display 17 is small and the processing power of the CPU 11 is low, the client terminal CT can obtain the music information of the search result correspondingly to the appropriate range of the number of maximum items displayed and the data size, it is possible to provide the search result in a shorter time compared to the case to obtain the search result with unnecessarily large data size.

Further, since the client terminal CT is configured to obtain the title with 32 characters as a search result, a little larger than the display capability of 24 characters of the display 17, by means of the configuration information, the rest of the characters, if it was in the range of remaining 8 characters, can be displayed immediately even if scrolling is instructed right after displaying the title with 24 characters.

Thus, since the CPU 11 of the client terminal CT may simply read out the title from the top according to the data size specified by the configuration information, it is not necessary to perform such conversion processing as to edit the title into a shorter sentence to fit with the display 17, the processing load may be very light.

Further, the CPU 11 of the client terminal CT can flexibly make adjustments by only changing the specifications of the list definition and the item definition of the configuration information, even when the display specification to display the list of music information is changed.

By means of the above configuration, the client terminal CT of the information service system 1 can obtain the search result efficiently and display it quickly within the capacity of the terminal itself, not exceeding the processing capability of the CPU 11 and the display capability of the display 17, to display the title, name of the artist or genre and the like as a search result from the music information stored in the music information storage area of the hard disk drive 21.

(4) Other Embodiments

In the embodiment described above, it was described when the client terminal CT, a data display control device, is configured to specify the list definition and the item definition of the configuration information correspondingly to the processing power of the CPU 11 and the display capability of the display 17, however, the present invention is not limited to this case and may be also applied to specify the list definition and the item definition of the configuration information in accordance with the data transfer rate of the bus 12 and other miscellaneous factors.

Further, in the above embodiment, it was described about the display 17 that can only display 1 line with 24 characters, however, the present invention is not limited to this case and it is also applicable to such case as a display, which can display 3 lines 36 characters or an ordinary display that can display characters full-screen.

In addition, in the above embodiment, the application of the present invention when the CPU 11 of the client terminal CT obtains the search result from the music information storage area of the hard disk drive 21 has been described, but the present invention is not limited to this application, but it may be also applied when the CPU 11 of the client terminal CT obtains music information from the relevant information server KS through the network 2.

Further, in the embodiment described above, it was described about the case where music information was searched to be obtained and displayed, however, the present invention is not limited to this case, but it is also applicable to obtain and display other various sorts of data to search from such as the program information broadcast by the radio station RS or the information of the contents delivered through TV stations and the Internet.

Further, in the embodiment described above, it was described about the case where the display 17 on the main body 11A was used to display the search result, however, the present invention is not limited to this case, but it is also applicable to use a separate display apart from the body 11A to display the search result.

Further, in the embodiment described above, it is described about the case where the CPU 11 is configured to lay out the display control program stored in the ROM 13 in advance, onto the RAM 20, and to execute the acquisition and display processing (FIG. 8) of the search result described above according to the display control program, however, the present invention is not limited to this case, but it is also possible to execute the acquisition and display processing of the search result described above by installing the media with the display control program in the client terminal CT.

Further, in the embodiment described above, it is described about the case where the data display control device of the present invention is composed of the hard disk drive 21 for the database and the CPU 11 for the search and control means, however, the present invention is not limited to this case, but it is also possible to configure the data display control device with other various sorts of circuit configurations.

Further, various processing in the embodiment described above can be run by hardware configurations shown in FIG. 2 through FIG. 5, however, they can also be performed by software.

In that case, various processing described above is run by installing programs comprising the software to a general use personal computer, and the like, which can perform the processing corresponding to the program through the network or the storage media.

Regarding the storage media in this case, for example, a magnetic disk (hard disk, floppy disk and the like), magnetic tape, optical disk (DVD, DVD-RAM, CD-ROM, CD-R (Recordable)/RW (ReWritable), etc., magneto-optical disk (MO (Magneto-Optical disk), etc.), semiconductor memory and the like may be employed.

In addition, in the embodiment described above, a radio broadcast by the radio station was applied as a broadcast receivable by the client terminal CT, however, it is also possible, not limited to the above, the client terminal CT is configured to receive the Internet radio broadcast and the satellite radio broadcast and obtain related information (radio broadcast information), or to receive a television broadcast by a television station and obtain various broadcast information and the like for the television program of the television broadcast form the server on the network.

Further, in the embodiment described above, the case where various circuits shown in FIG. 5 and the program module shown in FIG. 7 are implemented in the client terminal CT have been described, however, the present invention is not limited to this case, and the above implementation may also be applicable to various terminals other than the client terminal CT such as a mobile-phone handset or a personal computer and the like, and the terminals with such implementation can execute similar processing like the above-mentioned client terminal CT.

### INDUSTRIAL APPLICABILITY

The data display control device of the present invention is applicable to use, for example, for data acquisition and display of the data searched from a database.

1. A data display control device comprising:
a database storing a plurality of data with at least a first size;
search means for searching the database for at least one piece of data with the first size, based on an input search key; and
control means for controlling to obtain partial data with second size that is smaller than the first size and corresponding to a size of a display, out of the at least one piece of data found by the search means, from the database, and to display the partial data on the display.

2. The data display control device according to claim 1, further comprising
instruction means for issuing an instruction for scroll display of the partial data being displayed on the display, wherein
the control means controls to obtain remaining data other than the partial data from the database and to perform the scroll display on the display, in response to the instruction.

3. The data display control device according to claim 1, wherein
the control means controls to obtain a data part, that is larger than the second size and smaller than the first size, out of the at least one piece of data found by the search means, with the data part added to the partial data, from the database, and to perform scroll display on the display.

4. The data display control device according to claim 1, wherein
the control means controls to obtain a prescribed maximum number of data, out of a plurality of data found by the search means, from the database and temporarily store the prescribed maximum number of data in a storage medium, and displays a part of the prescribed maximum number of data on the display in accordance with a size of the display.

5. A data display control method comprising:
a search step of searching a database for at least one piece of data out of data with a first size, based on an input search key, the database storing a plurality of data with at least the first size; and
a control step of controlling to obtain partial data with a second size that is smaller than the first size and corresponding to a size of a display, out of the at least one piece of data found in the search step, from the database, and to display the partial data on the display.

6. A data display control program causing a data display control device to execute:
a search step of searching a database for at least one piece of data out of data with a first size, based on an input search key, the database storing a plurality of data with at least the first size; and
a control step of controlling to obtain partial data with a second size that is smaller than the first size and corresponding to a size of a display, out of the at least one piece of data found in the search step, from the database, and to display the partial data on the display.
